(19) United States
(12) Patent Application Publication
(10) Pub. No.: US 2009/0091516 A1
(43) Pub. Date: Apr. 9, 2009

(54) PLASMA DISPLAY DEVICE

(75) Inventor: Meensuk Kim, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD., Suwon-si (KR)

(21) Appl. No.: 12/242,313

(22) Filed: Sep. 30, 2008

(30) Foreign Application Priority Data
Oct. 4, 2007 (KR) 10-2007-0100038

(51) Int. Cl. G09G 3/28

(52) U.S. Cl. 345/60

(57) ABSTRACT

A plasma display device that can prevent errors is disclosed. The display independently detects each voltage from driving power supplies, and initializes the driver integrated circuits when a voltage variation occurs in any of the driving power supplies. The picture quality degradation of the plasma display panel is prevented by preventing errors of the integrated circuits resulting from a voltage drop of the driving power supplies.

### CROSS-REFERENCE TO RELATED APPLICATIONS

This application is based on and claims priority to Korean Patent Application No. 10-2007-0100038 filed on Oct. 4, 2007 in the Korean Intellectual Property Office (KIPO), the entire contents of which are hereby incorporated by reference.

### BACKGROUND

1. Field

The field relates to a plasma display device.

2. Description of the Related Technology

A plasma display device includes a driver comprising various integrated circuits for a picture processing, and driving signal generation and control. The driver is arranged opposite to a panel and fixed to a chassis by a connecting member.

The driver includes a picture processor converting an image signal into processable data, a logic controller, a driver generating a driving signal under the control of the logic controller, and a power supply supplying driving signal power and driving power.

The driving signal power is a power for gas discharge of the plasma display device. The driving signal power is a voltage of tens to hundreds of volts. The driving power is a power for driving the integrated circuits, and is generally several volts. Accordingly, the power supply supplies two kinds of direct current voltages, that is, the driving signal power and the driving power by converting an alternating current power supply. The driving signal power and the driving power are not generated only as voltages of uniform potential, but rather have voltages of various potentials.

The driving power is a power for driving various integrated circuits, and affects operation of the plasma display device. The integrated circuits generate and supply the driving signal for the operation of plasma display device. Accordingly, when the integrated circuits are operated stably, the plasma display device displays a picture stably. The driving power supply should be provided stably without a change so that the integrated circuits are operated stably.

However, there is a circumstance that the power supply does not supply the driving power supply within a desired reference range, that is, a voltage range required for a stable operation of the integrated circuits due to electronic wave noise, etc. Accordingly, if the driving power supply deviates from the reference range, the integrated circuits are not operated stably. If the integrated circuits are not operated stably, an error occurs in controlling the driving signal or processing the image signal. Errors of the integrated circuits affect normal screen reproduction of the plasma display device. Accordingly, even when the driving power supply deviates from the reference range, it becomes necessary to make the integrated circuits to be operated stably.

### SUMMARY OF CERTAIN INVENTIVE ASPECTS

One aspect is a plasma display device comprising a power supply configured to supply at least two driving power voltages, the voltages having different voltage levels, a logic controller comprising at least two integrated circuits, each integrated circuit configured to receive one of the driving power voltages from the power supply, and an element reset unit configured to detect voltage variation in each of the driving power voltages and to output a reset signal to the at least two integrated circuits, when any one of the driving power voltages deviates from a reference range.

Another aspect is a method of operating a plasma display device, the method comprising supplying at least two power voltages to at least two integrated circuits, each integrated circuit configured to receive one of the power voltages, where the power voltages each have a different voltage level, generating an error signal in response to at least one of the power voltages deviating from a voltage range, and resetting the integrated circuits in response to the error signal.

### BRIEF DESCRIPTION OF THE DRAWINGS

The above and other aspects and features will be more apparent from the following detailed description taken in conjunction with the accompanying drawings, in which:

FIG. 1 is a block diagram of a plasma display device according to an exemplary embodiment;

FIG. 2 is a block diagram of an element reset unit of the plasma display device according to an exemplary embodiment;

FIG. 3 is a block diagram illustrating a circuit of the element reset unit of FIG. 2; and

FIG. 4 is a waveform diagram illustrating an operation of the element reset unit according to an exemplary embodiment.

### DETAILED DESCRIPTION OF CERTAIN INVENTIVE EMBODIMENTS

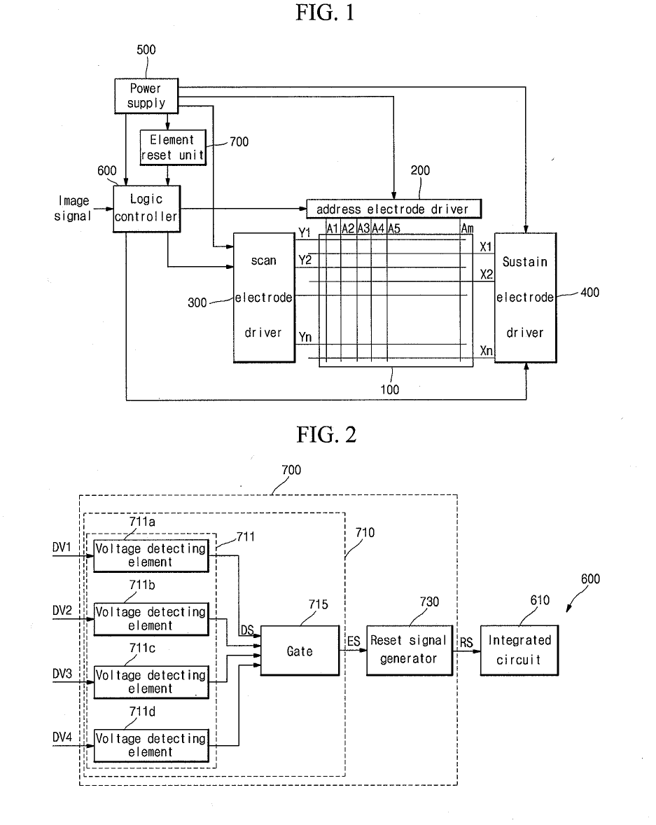

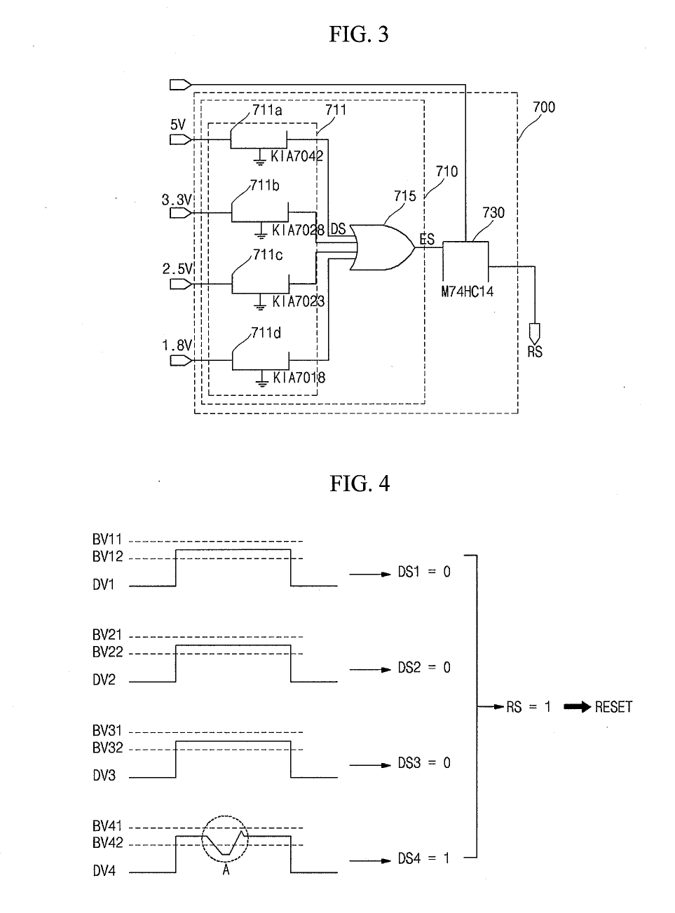

FIG. 1 is a block diagram of the plasma display device according to one exemplary embodiment. FIG. 2 is a block diagram of an element reset unit of the plasma display device according to an exemplary embodiment. FIG. 3 is a block diagram illustrating a circuit of the element reset unit of FIG. 2. FIG. 4 is a waveform diagram illustrating an operation of the element reset unit according to one exemplary embodiment.

Referring to FIG. 1, the plasma display device includes a plasma display panel 100, an address electrode driver 200, a scan electrode driver 300, a sustain electrode driver 400, a power supply 500, a logic controller 600 and an element reset unit 700.

The plasma display device prevents errors by independently detecting voltage variation of each driving power supply when at least two driving power supplies are used, and initializing integrated circuits when the voltage variation occurs in any one of the driving power supplies.

The plasma display panel 100 includes a plurality of address electrodes (A1-Am) arranged in a horizontal direction, a plurality of scan electrodes (Y1-Yn) arranged in a vertical direction, and a plurality of sustain electrodes (X1-Xn). The sustain electrodes (X1-Xn) are formed corresponding to the scan electrodes (Y1-Yn). The plasma display panel 100 includes a first glass substrate whereon the sustain electrodes (X1-Xn) and the scan electrodes (Y1-Yn) are arranged, and a second glass substrate whereon the address electrodes (A1-Am) are arranged. The two glass substrates, which oppose each other and have a discharge space between them, are arranged so that the address electrodes (A1-Am) lies at substantially right angles to the scan electrodes (Y1-Yn) and the sustain electrodes (X1-Xn). The discharge space is near where the address electrodes (A1-Am) crosses the scan electrodes (Y1-Yn) and the sustain electrodes (X1-Xn).

The address electrode driver 200 receives an address electrode driving signal from the logic controller 600, and applies a display data signal to each address electrode (A) so as to select the discharge cells to be displayed.

The scan electrode driver 300 receives a scan electrode (Y) driving signal from the logic controller 600 and applies the driving voltage to the scan electrode (Y).

The sustain electrode driver 400 receives a sustain electrode (X) driving signal from the logic controller 600 and applies the driving voltage to the sustain electrode (X).

The power supply 500 supplies the power for driving the plasma display device to the logic controller 600 and each driver 200, 300 and 400. More particularly, the power supply 500 converts an alternating current power supply into a direct current voltage, and supplies the direct current voltage to the logic controller 600, the address electrode driver 200, the scan electrode driver 300 and the sustain electrode driver 400. Accordingly, the power supply 500 includes an AC-DC converter (not shown) converting the alternating current voltage into the direct current voltage. The power supply 500 includes a DC-DC converter (not shown) supplying the converted direct current voltage to the driving signal power supplies (DSV) having different voltages, and to a plurality of the driving power supplies (DV) having different voltages

The driving signal power is supplied from the power supply 500 to each driver 200, 300 and 400, has a voltage range of approximately tens to hundreds of volts, and are supplied for a discharge in the plasma display panel 100. The driving signal power is supplied from the power supply 500 to the logic controller 600, has a voltage range of several to tens of volts, and are supplied for driving the integrated circuits. The power supply 500 supplies a power supply for operating the integrated circuits installed in each driver 200, 300 and 400.

The power supply 500 supplies the driving power supply corresponding to the number of integrated circuits needing different voltages. The integrated circuits comprise the integrated circuits of the logic controller 600. The integrated circuits may additionally or alternatively include the integrated circuits of one or more of the drivers 200, 300 and 400.

The driving power supply is formed so as to have a voltage corresponding to the voltage needed for the integrated circuits. Accordingly, when the integrated circuits comprise two integrated circuits needing driving voltages that are different from each other, the driving power supply comprises two driving power supplies having voltages that are different from each other. For example, referring to FIG. 2, the driving power supply may have four voltages DV1, DV2, DV3 and DV4. In other words, the driving power supply comprises a first driving power supply DV1, a second driving power supply DV2, a third driving power supply DV1, and a fourth driving power supply DV1, which are 5V, 3.3V, 2.5V and 1.8V, respectively. Each of the voltages is maintained within a reference range (BV). The reference range (BV) is a power voltage range for each integrated circuit to function within its specified performance parameters. The reference range (BV) has a lower limit voltage and an upper limit, and in some embodiments, has only a lower limit voltage or only an upper limit voltage. For example, when the first driving power supply DV1 is 5V, the lower limit voltage (BV11) and the upper limit voltage (BV12) of the reference range (BV) may be set to about 4.5V and about 5.3V, respectively. When the second driving power supply DV2 is 3.3V, the lower limit voltage (BV21) and the upper limit voltage (BV22) of the reference range (BV) may be set to about 2.9V and about 3.5V, respectively. When the third driving power supply DV3 is 2.5V, the lower limit voltage (BV31) and the upper limit voltage (BV32) of the reference range (BV) may be set to about 2.3V and about 2.7V, respectively. When the fourth driving power supply DV4 is 1.8V, the lower limit voltage (BV41) and the upper limit voltage (BV42) of the reference range (BV) may be set to about 1.8V and about 2.0V, respectively. On the other hand, the reference range (BV) may be set differently according to specifications of the integrated circuits to which the driving power supply is supplied.

The logic controller 600 receives an image signal, and converts the image signal into data processable in the address electrode driver 200, the scan electrode driver 300 and the sustain electrode driver 400. The logic controller 600 outputs an address electrode (A) driving signal, a sustain electrode (X) driving signal and a scan electrode (Y) driving signal. The logic controller 600 is driven by dividing a frame into a plurality of subfields. Each subfield has a reset period, an address period and a sustain period.

The logic controller 600 includes various integrated circuits 610 such as an ASIC (Application-Specific Integrated Circuit), a microcontroller (MICOM) and a DDR memory. The integrated circuits 610 are driven by the driving power supply DV supplied from the power supply 500. The integrated circuits 610 are driven with the ASIC driving voltage of about 5V, the ASIC core voltage of about 1.8V, the microcontroller I/O (Input/Output) voltage of about 3V, and a memory I/O voltage of about 2.5V supplied from the driving power supply. The integrated circuits 610 can be driven with other voltages according to the specifications of the integrated circuits.

Referring to FIG. 2, the element reset unit 700 includes a voltage variation detector 710 and a reset signal generator 730. The element reset unit 700 detects if the driving power supplied from the power supply 500 deviates from the reference range. The element reset unit 700 generates the reset signal and transmits the generated reset signal to the integrated circuits 610 so that the integrated circuits can be initialized, when the driving power supply deviates from the reference range.

In some embodiments, the element reset unit 700 is formed independently and is separated from the power supply 500 and the logic controller 600. And it can be formed integrally with the power supply 500 or the logic controller 600. The element reset unit 700 can be formed integrally on the board that the logic controller 600 is on, or can be formed integrally on the board that the power supply 500 is on. In some embodiments, the element reset unit 700 can operate the integrated circuits 610 of the logic controller 600 as well as the integrated circuits of each driver 200, 300 and 400 in a similar way.

Referring to FIG. 2, the voltage variation detector 710 includes a voltage detecting element 711 and a gate 715. The voltage variation detector 710 is electrically coupled to the power supply 500. The driving power supply is input to the voltage variation detector 710. Accordingly, the voltage variation detector 710 detects if the driving power voltages from the power supply 500 deviate from the allowable reference range.

The voltage detecting element 711 is formed to have as many voltage detecting elements as the number of the driving power supplies DV. When the driving power voltages from the power supply 500 are at least two levels, at least two voltage detecting elements are formed. Referring to FIG. 2, because the number of driving power supplies supplied from the power supply 500 is four, four voltage detecting elements 711a, 711b, 711c and 711d are used. The voltage detecting element 711 includes a first voltage detecting element 711a, a second voltage detecting element 711b, a third voltage detecting element 711c and a fourth voltage detecting element 711d. Each of the voltages of the power supply 500 is input to one of the voltage detecting elements 711a, 711b, 711c, and 711d, which detect if the corresponding voltage is out of its allowable range.

The voltage detecting element 711 may comprise one or more integrated circuits used for detecting voltage. The voltage detecting element 711 may comprise a different element for each voltage monitored. For example, the voltage detecting element 711 may comprise integrated circuits for detecting voltage such as KIA7045, KIA7029, KIA7023 and KIA7018. The KIA70xx series made by KEC Ltd. Co, which are the integrated circuits for detecting the lower limit voltage. Of course, other products made by other companies can be used as the voltage detecting element 711.

The voltage detecting element 711 is electrically coupled to each driving power supply. The voltages of the driving power supply are separately input to the voltage detecting element 711. The voltage detecting element 711 detects if the voltages of the driving power supply deviates from a reference range. The voltage detecting element 711 also detects if the voltage is below lower limit or above the upper limit.

In some embodiments, if any of the voltages of the driving power supply deviates from its reference range, the voltage detecting element 711 detects the voltage deviation, and generates a detecting signal (DS). For example, if one of the driving power supply voltages is lower than its lower limit, the voltage detecting element 711 generates a detecting signal and transmits the detecting signal to a gate 715.

In some embodiments, the gate 715 comprises a logic gate, more particularly, a sum logic gate (OR GATE). The gate 715 is electrically coupled to the voltage detecting element 711, so that the detecting signals are input to the gate. The gate 715 is electrically coupled to the reset signal generator 730 so as to output the error signal (ES). The gate 715 is formed as the sum logic gate that inputs the detecting signal of the voltage detecting element 711 and outputs the error signal transmitted to the reset signal generator 730. Accordingly, the gate 715 outputs the error signal to the reset signal generator 730, if the detecting signal is inputted from any one of the voltage detecting elements 711.

The gate 715 may, for example, be formed as any of an AND, NAND, NOR, XOR, or XNOR gate according to the output specifications of the voltage detecting elements 711. Other gates and logic combinations may also be used.

The reset signal generator 730 includes an inverter, more particularly, a Schmitt trigger or a Schmitt inverter element. For example, the reset signal generator 730 can be formed of the elements such as M74HCxx and M74HCxx. The Schmitt trigger is an element generally used as an inverter.

The reset signal generator 730 is electrically coupled to the gate 715 to receive the error signal outputted from the gate 715. The reset signal generator 730 is connected to the integrated circuits 610 of the logic controller 600 to output a reset signal (RS). The reset signal generator 730 is electrically coupled to the integrated circuits 610 needing the reset signal at the logic controller 600. Accordingly, the reset signal generator 730 transmits the reset signal to the integrated circuits 610, when an error signal is received from the gate 715. In response to the reset signal, the integrated circuits 610 stop data processing, and then are initialized. After the integrated circuits 610 are initialized, prior unprocessed data may again be processed. Because the integrated circuits 610 are initialized by the reset signal, an error occurring from the power supply voltage being out of range does not propagate to drivers 200, 300 and 400, and thus a picture quality of the plasma display panel 100 is improved.

Hereinafter, an operation of the plasma display device according to one exemplary embodiment will be described.

FIG. 4 is a waveform diagram illustrating an operation of the element reset unit according to one exemplary embodiment. Hereinafter, the operations of the element reset unit 700, the power supply 500 and the logic controller 600 connected to the element reset unit 700 according to one exemplary embodiment will be described. Because some operation of the plasma display device is the same as or similar to generally known operation, some explanation will be omitted.

The voltage variation detector 710 is electrically coupled to the driving power supply of the power supply 500. The various voltages of the driving power supply are separately input to the voltage variation detector 710. In some embodiments, the driving power supply voltages are about 5V, about 3.3V, about 2.5V and about 1.8V, respectively. Four voltage detecting elements 711 of the element reset unit 700 are formed according to the number of driving power supply voltage levels. In other words, about 5V is input to the first voltage detecting element 711, and about 3.3V is inputted to the second voltage detecting element 711, and about 2.5V is inputted to the third voltage detecting element 711, and about 1.8V is inputted to the fourth voltage detecting element 711. The voltage detecting element 711 detects if each voltage input from the driving power supply is within the reference range. In other words, the voltage detecting element 711 detects if each voltage is within each reference range.

The voltage detecting element 711 outputs the detecting signal if the any of the input voltage deviates from its reference range. Referring to FIG. 4, as the voltage lower than BV42, which is the lower limit voltage, is input to the fourth voltage detecting element 711d during a period A, the detecting signal (DS4) is “1”. On the other hand, because the voltage within the reference range is input to the first, second and third voltage detecting elements 711a, 711b and 711c, the detecting signal (DS1, DS2 and DS3) is “0”. The gate 715 outputs the error signal to the reset signal generator 730 because of the detecting signal (DS4) from the fourth voltage detecting element 711d. The reset signal generator 730, generates and outputs the reset signal of “1”. Accordingly, the integrated circuits are initialized by the reset signal.

Therefore, errors can be prevented by detecting each voltage variation of a plurality of the driving power supplies, and initializing the integrated circuits when a voltage variation occurs in any one of the driving power supplies. In addition, the picture quality degradation of the plasma display panel can be prevented by preventing errors the integrated circuits resulting from a voltage drop of the driving power supply.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A plasma display device comprising:
a power supply configured to supply at least two driving power voltages, the voltages having different voltage levels;
a logic controller comprising at least two integrated circuits, each integrated circuit configured to receive one of the driving power voltages from the power supply; and
an element reset unit configured to detect voltage variation in each of the driving power voltages and to output a reset signal to the at least two integrated circuits, when any one of the driving power voltages deviates from a reference range.

2. The plasma display device of claim 1, wherein the element reset unit comprises:
a voltage variation detector coupled to the power supply to output an error signal, when any one of the driving power voltages deviates from the reference range, and
a reset signal generator coupled to the voltage variation detector to output a reset signal in response to the error signal.

3. The plasma display device of claim 2, wherein the voltage variation detector comprises:
a voltage detecting element for each of the driving power voltages, the voltage detecting elements each configured to output a detecting signal when the corresponding driving power voltage deviates from the reference range, and
a gate connected to the voltage detecting elements, the gate configured to output the error signal in response to receiving any of the detecting signals.

4. The plasma display device of claim 3, wherein the voltage detecting element comprises an integrated circuit.

5. The plasma display device of claim 3, wherein the gate comprises an OR logic gate.

6. The plasma display device of claim 2, wherein the reset signal generator comprises a Schmitt trigger element.

7. The plasma display device of claim 1, wherein the reference range comprises an upper limit voltage and a lower limit voltage.

8. The plasma display device of claim 1, wherein the reference range comprises either a lower limit voltage or an upper limit voltage.

9. The plasma display device of claim 1, wherein the element reset unit is integrally formed with the power supply.

10. The plasma display device of claim 1, wherein the element reset unit is integrally formed with the logic controller.

11. The plasma display device of claim 1, wherein the integrated circuit comprises at least two of an ASIC, a microcontroller and a memory.

12. The plasma display device of claim 1, wherein the logic controller comprises at least four integrated circuits, and the power supply is configured to provide at least four driving power voltages.

13. The plasma display device of claim 12, wherein the voltage levels of the four driving voltages comprise levels of about 5V, about 3.3V, about 2.5V, and about 1.8V.

14. A method of operating a plasma display device, the method comprising:
supplying at least two power voltages to at least two integrated circuits, each integrated circuit configured to receive one of the power voltages, wherein the power voltages each have a different voltage level;
generating an error signal in response to at least one of the power voltages deviating from a voltage range; and
resetting the integrated circuits in response to the error signal.

15. The method of claim 14, wherein resetting the integrated circuits comprises initializing the integrated circuits.

16. The method of claim 14, wherein generating an error comprises monitoring each of the power voltages and generating a signal indicating whether the power voltage is out of the voltage range.

17. The method of claim 14, wherein each of the integrated circuits is associated with a single power voltage, and each of the power voltages is associated with a different voltage range.

18. The method of claim 15, wherein each of the voltage ranges is based on the power voltage range for the integrated circuit associated therewith to function within its specified performance parameters.

19. The method of claim 14, wherein each of the integrated circuits is associated with a single power voltage, and each of the power voltages is associated with a different voltage range.

20. The method of claim 14, wherein supplying at least two power voltages to at least two integrated circuits comprises supplying at least four power voltages to at least four integrated circuits, the four power voltages having voltage levels about equal to 5V, 3.3V, 2.5V, and 1.8V, respectively.
